(19) United States
(12) Patent Application Publication
(10) Pub. No.: US 2004/0139658 A1
(43) Pub. Date: Jul. 22, 2004

(54) Method and apparatus facilitating closure of hoistway door

(76) Inventor: Kelly L. Marshall, Bayside, TX (US)

Correspondence Address: G. Turner Moller, 720 American Bank Plaza, Corpus Christi, TX, 78475, US

(21) Appl. No.: 10/346,788

(22) Filed: Jan. 21, 2003

(51) Int. Cl. E06B 11/00

(52) U.S. Cl. 49/352; 49/360

(57) ABSTRACT

A method and apparatus for facilitating closure of an elevator hoistway door generally comprises the steps of affixing a door closer device to the hoistway door and securing a cable, extended from the door closer device, to a terminal off the hoistway door. The door closer device comprises a sheave repeatedly circumscribed by an elongate channel for receiving the cable therein and a spring adapted to oppose extension of the cable from said door closer device. The channel, which generally prevents overlap of the cable during retraction into the door closer device, preferably forms a conical helix during the final retraction of the cable, thereby increasing the force exerted upon the door by the cable as the door approaches the door closed position.

### FIELD OF THE INVENTION

The present invention relates to elevator safety devices.

More particularly, the invention relates to a mechanical door closer for increasing the closing force on the door as it approaches the door closed position.

### BACKGROUND OF THE INVENTION

Modern elevator installations typically comprise one or more hoistway door panels 41 on each landing to block access to the hoistway door 10 when the elevator cab is not present. As shown in FIG. 1, the hoistway door panels 41 are typically suspended from the hoistway header 16 by a plurality of hangers 11. The panels 41 are usually affixed to the hangers 11 with conventional mounting bolts 14. The hangers 11, which usually comprise one or more pulleys 12, allow lateral translation of the door panels 41 along a track 15 affixed to the hoistway header 16. A relating cable 17 is generally provided in multiple panel installations in order to coordinate the opening and closing of the panels 41. As is generally known to those of ordinary skill in the art, a relating cable door clamp 18 affixed to one hoistway door panel 41 and a relating cable dead end clamp 19 affixed to the other hoistway door panel 41 establishes the desired operating relationship between the panels 41.

As is also known to those of ordinary skill in the art, the hoistway door 10 is opened and closed in normal operation through interaction with the cab door (not shown) as the cab comes to rest at a particular landing. In particular, a power door operator, which is normally located atop the cab, opens or closes the cab door through a drive arm, cable, belt, screw drive or the like. A clutch mechanism engages a roller assembly 20 to couple the cab door to the hoistway door 10 for opening and closing. A vertically disposed clutch on the cab door then engages an upper clutch roller 22 and lower clutch roller 23 as the cab settles upon a landing. Because the lower clutch roller 23 is generally offset from the upper clutch roller 22, engagement of the clutch with the rollers 22, 23 serves to release a mechanical latching device 25 through an interposed clutch linkage 24. Release of the mechanical latching device 25 allows the hoistway door 10 to be opened as a lateral force is applied from the cab door to the rollers 22, 23 through the clutch.

As the cab prepares to leave a particular landing, the power door operator reverses the position of the drive arm (or other device) to force the cab doors closed. The clutch engages the rollers 22, 23 from their side opposite that engaged during the opening operation, thereby forcing the hoistway door 10 closed and re-engaging the mechanical latching device 25. Additionally, electrical contacts 26, typically collocated with the mechanical latching device 25 in an interlock assembly, will then signal the elevator controller to confirm that the hoistway door 10 has in fact been closed, enabling the elevator cab to depart the landing.

Because the device 25 may fail, however, additional safety devices are generally required in order to ensure that the hoistway door 10 closes and remains closed if, for any reason, the elevator cab leaves the landing prior to door closing. Typically, a door closer device 27 is provided to facilitate and ensure closing of the hoistway doors 10. In the past, the door closer device 27 has generally comprised a closer reel attached to one of the hoistway door panels 41 by a bearing or bushing assembly 30 located in a passage 42 around the central axis 31 of the door closer device 27. A spring 32 within a spring cavity 28 engages a ratchet 29 within the door closer device 27 to produce tension on a closer reel cable 33, which may be extended from the door closer device 27. A distal end of the closer reel cable 33, generally terminated with a cable eyelet 34, is fixedly secured to the hoistway header 16 through a cap screw 35. As is known to those of ordinary skill in the art, however, the cable eyelet 34 may, in multiple door installations, be affixed to a second hoistway door panel 41. Likewise, as is known to those of ordinary skill in the art, the door closer device 27 could be affixed off of the hoistway door 10—for example, on the hoistway header 16, while the cable 33 is affixed to one of the door panels 41.

In operation, as the hoistway door 10 opens, the closer reel cable 33 is extended from the door closer device 27. As the closer reel cable 33 is pulled from the doors closer device 27, increasing opposing force is applied on the reel cable 33 from the spring 32. In the event of an electrical or mechanical failure preventing the otherwise normal closing of the hoistway door 10, tension on the closer reel cable 33 serves to ensure that the hoistway door 10 closes and remains closed. Unfortunately, the door closers as presently known the art are often ineffective in extreme conditions.

In windy areas, such as coastal or lakeshore regions, or in air conditioned buildings with windows that may be opened, an in rush of air is often created during heavy traffic hours as a result of the negative pressure in the building. This in rush of air causes an air current in the hoistway, which acts as an air duct. As the elevator cab reaches a landing, air pressure within the hoistway escapes rapidly through the hoistway door 10. As the door 10 attempts to close, a jet nozzle effect is created whereby the resultant high wind velocity puts such a stress on the hoistway door 10 that it often fails to close, causing the elevator to initiate a recycle mode. In this condition, the known door closer devices 27 are generally unable to force the hoistway door 10 to close. To date, the solution to this problem has resided in a call-back for maintenance for the elevator. In response to the call-back, the service technician generally adds a loop of the closer 20 reel cable 23 about the closer reel, thereby increasing tension on the spring 32. Unfortunately, as wind conditions change, or traffic flows through the building lessen, the excess tension on the closer reel cable 33 can cause the hoistway door 10 to close too rapidly in the absence of the jet nozzle effect. The door panels 41 come together with excess force and the result is again that the elevator enters a recycle mode and fails to operate. To date, as before, the typical response has been yet another maintenance call-back whereafter the service technician will remove the previously added cable loop from about the closer reel.

It is therefore an overriding object of the present invention to improve upon the prior art by providing a door closer device and method that is able to effectively operate a hoistway door in a variety of weather and/or usage conditions.

It is a further object of the present invention to provide such a door closer device that is reverse compatible with existing installations and of comparable expense to those presently available.

Finally, it is yet another object of the present invention to provide such a door closer device that has an extended life cycle, thereby reducing cost to the elevator owner and maintaining elevator contractor.

### SUMMARY OF THE INVENTION

In accordance with the foregoing objects, the present invention—a method and apparatus for facilitating closure of an elevator hoistway door—generally comprises the steps of affixing a door closer device to the hoistway door and securing an end of a cable to a terminal off the hoistway door. The door closer device comprises a sheave repeatedly circumscribed by an elongate channel, for receiving the cable, and a spring adapted to oppose extension of the cable from the door closer device. In the preferred embodiment, the channel forms a conical helix during the final retraction of the cable as it moves the door to the door closed position, thereby countering any weakening of the spring as the cable is finally retracted into the door closer device and producing an increased force on the cable near the door closed position.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a partial side elevational view, a typical center opening hoistway door installation as may incorporate the teachings of the present invention;

FIG. 2 shows, in an exploded perspective view, the door closer device as manufactured according to the preferred embodiment of the present invention;

FIG. 3 shows, in a bottom cross-sectional view taken along the line 3-3 of FIG. 5, the door closer device of FIG. 2;

FIG. 4 shows, in a top cross-sectional view taken along the line 4-4 in FIG. 5, the door closer device of FIG. 2;

FIG. 5 shows, in a side elevational view, the door closer device of FIG. 2;

FIG. 6 shows, in a side cross-sectional view taken along the lines 6-6 in FIG. 4, the door closer device of FIG. 2;

FIG. 7 is a graph showing the relationship, in a conventional commercially available door closer, between the force produced by the spring and the force produced at the end of the cable;

FIG. 8 is a graph showing the relationship, in a prior art door closer of one design, between the force produced by the spring and the force produced at the end of the cable;

FIG. 9 is a graph showing the relationship, in a prior art door closer of another design, between the force produced by the spring and the force produced at the end of the cable; and

FIG. 10 is a graph showing the relationship, in a door closer of this invention, between the force produced by the spring and the force produced at the end of the cable.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

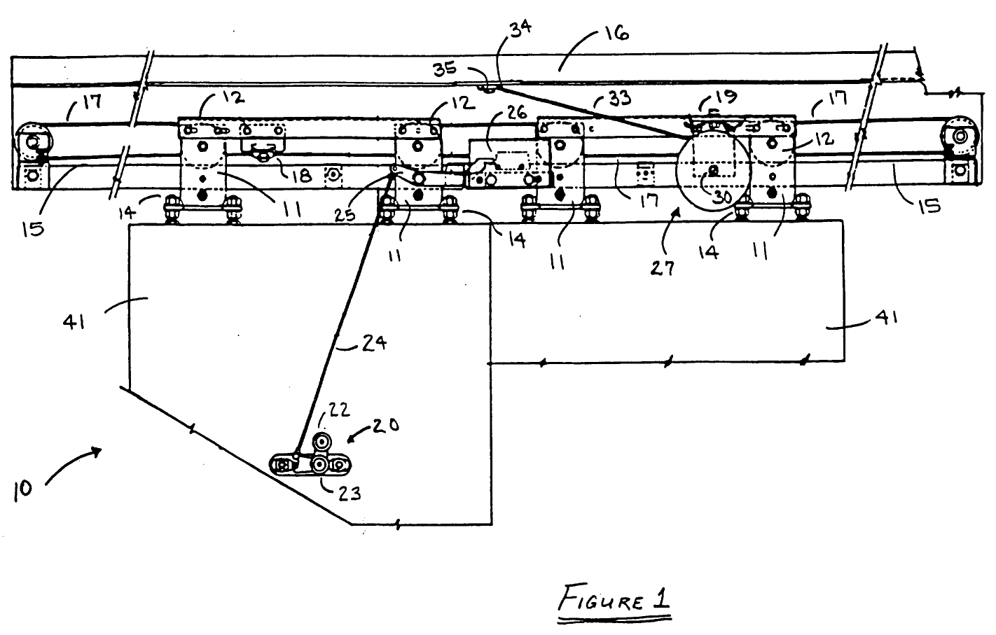

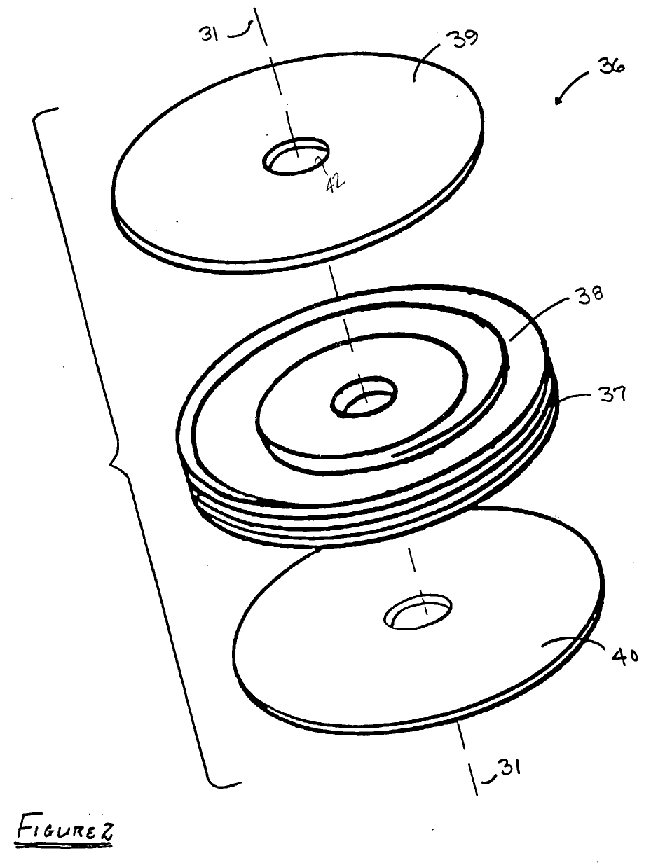

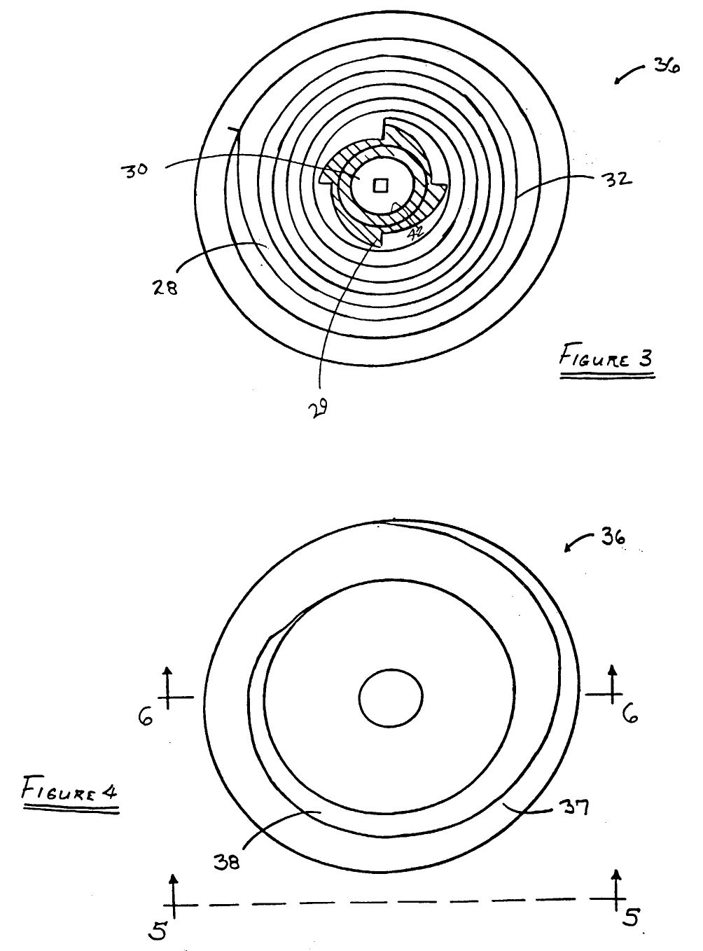

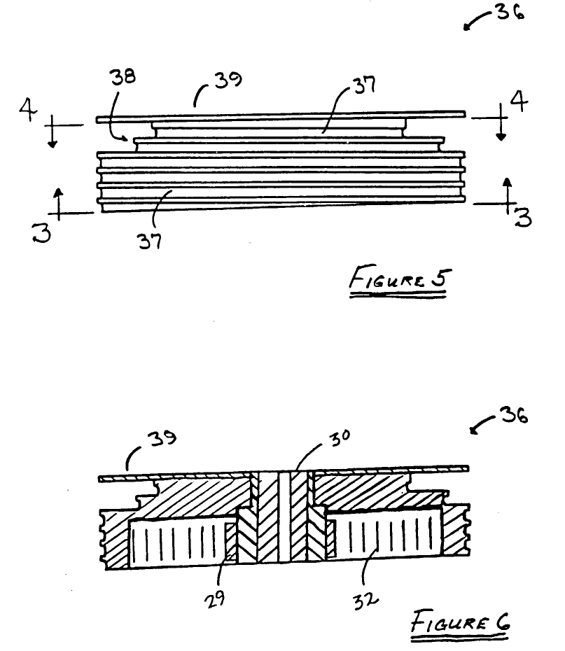

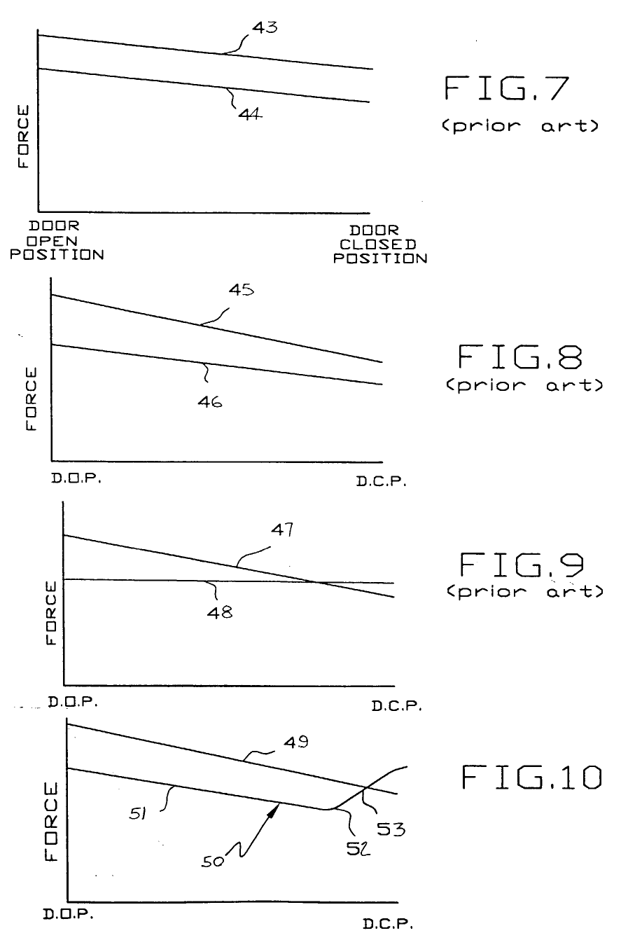

Referring now, in particular, to FIGS. 2 through 6, the door closer device 27 of the present invention is shown to generally comprise a sheave or reel 36 formed by providing an elongate channel 37 repeatedly about the circumference of the closer reel. In a preferred embodiment, the channel 37 forms a section of more-or-less constant diameter on one side of the reel and a conical helix 38 in approximately the last twelve inches of draw of the closer reel cable 33. In particular, conical helix 38 is calculated so the cable 33 delivers a door closing force that increases during the last movement of the cable 33 despite the fact that the spring 32 is delivering less force near the door closed position as will be more fully explained hereinafter in conjunction with the description of FIGS. 7-10. Although the exact dimensions for the conical helix 38 will vary depending upon the particular installation, the calculations necessary to arrive at the desired result are readily within the grasp of those of ordinary skill in the art. As also shown in the Figures, a top plate 39 and a bottom plate 40 are provided as known in previously employed embodiments. The top plate 39 in the present invention serves also to ensure that should the closer reel cable 33 become disengaged from the channel 37 that the cable 33 will remain about the sheave 36, whereafter one cycle of the door closer device 27 the cable 33 will automatically reengage the channel 37.

In operation, the tension provided to the closer reel cable 33 from the spring 32, which ordinarily falls off during the final retraction of the cable 33 due to operation of spring 32 at the extent of its effective region, is compensated by two factors. First, maintenance of cable the closer reel 33 within the channel 37 prevents overlapping of the cable 33, thereby maintaining the radius of the moment arm about central axis 31 through the door closer device 27. Second, during the final retraction of the cable 33, direction of the closer reel cable 33 into the conical helix 38 reduces the radius of the moment arm about central axis 31. In this manner, the reduction in force resultant operation in the weaker region of the spring 32 is counteracted by the design of the sheave 36.

FIGS. 7-10 are analogous. Each shows the force produced by a spring of a door closer and the force produced by the cable. The door closed position is shown on the right and the door open position is shown on the left. The slopes of the lines are exaggerated for purposes of illustration. The values in FIG. 10 for the force produced by the cable were obtained by attaching the cable to the hook of a weighing device of the type incorporating a spring. The force produced by the cable was measured at various distances from the door closer.

FIG. 7 shows a line 43 representing the force produced by the spring of a conventional commercially available door closer and a line 44 representing the force produced on the end of the cable of a conventional commercially available door closer. A conventional commercially available door closer includes a spiral spring driving a reel of constant diameter on which the cable is wound. A typical commercially available door closure is Model ML-4402 available from the Hunter Spring Division of Ametek, Hatfield, Pa. A comparison of the lines 43, 44 shows that the reel provides no mechanical advantage to the cable, which is predictable because the reel is of constant diameter. It will be seen that the line 43, being above the line 44, shows that the spring delivers slightly more force than is delivered by the cable, the difference being lost in conventional mechanical ways, as through friction and the production of heat. It will also be seen that the spring and cable produce the minimum force when the door is at, or approaches, the door closed position and the maximum force when the door is at, or approaches, the door open position. In a way, this is logical because at the door open position, the door closer has to produce a maximum force to overcome inertia of the door and door closing mechanisms.

FIG. 8 shows a line 45 representing the force produced by the spring of the device shown in Australian Patent 113,360 and a line 46 representing the force produced on the end of the cable of a conventional commercially available door closer. This door closer has a reel which is conical from back to front in a more-or-less constant manner. A comparison of the lines 45, 46 shows that the reel provides an increasing mechanical advantage to the cable as the cable approaches the door closed position, which is predictable because the reel is of minimum diameter at the door closed position and maximum diameter at the door open position. Thus, the lines 45, 46 diverge toward the door open position where the mechanical advantage is least. It will be seen that the line 45, being above the line 46, shows that the spring delivers slightly more force than is delivered by the cable, the difference being lost in conventional mechanical ways, as through friction and the production of heat.

FIG. 9 shows a line 47 representing the force produced by the spring of the device shown in U.S. Pat. No. 5,054,162 and a line 48 representing the force produced on the end of the cable of this device. This door closer has a reel which is conical from back to front and is steeply sloped toward the back of the reel. A comparison of the lines 47, 48 shows that the reel provides a substantially increasing mechanical advantage to the cable as the cable approaches the door closed position, which produces a constant force on the cable from the door open position to the door closed position. Thus, the line 47, representing the force delivered by the spring, slopes to a minimum force at the door closed position while the line 48, representing the force delivered by the cable, is substantially constant throughout. It will be seen that the line 47, being above the line 48, shows that the spring delivers slightly more force than is delivered by the cable, the difference being lost in conventional mechanical ways, as through friction and the production of heat.

FIG. 10 shows a line 49 representing the force produced by the spring of this invention. Spiral springs of the type used in door closing devices produce force diagrams of substantially different shape and slope, depending on the design of the spring and the line 49 is merely representative of a typical spiral spring. Thus, the line 49 is illustrated as generally linear which is a typical force diagram of a spiral spring of modern design. So far as is known, all commercially available spiral springs produce greater force when they are wound up, i.e. at the door open position, than when they are paid out, i.e. at the door closed position.

The curve 50 represents the force produced on the end of the cable of this device. It will be seen that the curve 50 is of complex shape having a section 51 which is more-or-less parallel to the line 49 and represents the situation where the cable is being wound or unwound off the large more-or-less constant diameter section of the reel or sheave 36. The shape of the curve 50 changes at a location 52 which is where the cable begins to wind or unwind on the conical helix 38. The section 53 of the curve 50 shows that the force applied by the cable increases as the door approaches the door closed position. Thus, the location 52 is about twelve inches from the end of cable movement although this distance is subject to considerable selection.

Thus, the door closer of this invention provides an optimum force for the operation of hoistway doors. The maximum force of the spring is available at the door open position which is advantageous to start movement of the door and overcome its inertia and the inertia of the door moving mechanisms shown in FIG. 1. Instead of the force of the cable falling off to a minimum, or even remaining constant, at the door closed position, the force delivered by the cable 33 increases to overcome any extraneous forces on the door, such as induced by wind, tending to prevent the door from closing.

The delivery of optimum forces by the door closer of this invention is accomplished with a door closer of minimum thickness which allows the door closer to be used to retrofit existing conventional door closers and occupy the limited space available.

Applicant has found, through testing, that the force obtained as a result of this novel implementation is generally sufficient to overcome the jet nozzle effects of wind without the necessity for the repeated maintenance call-backs inherent in the prior art. Additionally, in the preferred embodiment of the present invention, Applicant has found that the cable lifetime may be extended through operation within the channel 37 due to the prevention of kinking and bending as the cable 33 would otherwise overlap itself. Finally, because the sheave 36 of the present invention is preferably manufactured of a lubricant impregnated plastics material, minimum friction with the cable 33 is generated and the components coming into contact with the sheave 36 are protected from corrosion.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. In any case, because the scope of the present invention is much broader than any particular embodiment, the foregoing detailed description should not be construed as a limitation of the scope of the present invention, which is limited only by the claims appended hereto.

What is claimed is:

1. A method for facilitating closure of an elevator hoistway door movable between a door open position and a door closed position, comprising the steps of:
affixing a door closer to a hoistway door panel, said door closer comprising a sheave repeatedly circumscribed by an elongate channel having a conical helical section operative when the door approaches the door closed position to increase the mechanical advantage of a spring; an elongate tensile element received within said channel, said cable having a first end fixedly secured to said door closer and a second end extendable from said door closer; a spring housed within said door closer, said spring being adapted to oppose extension of said second end of said tensile element from said door closer; and wherein said tensile element may be substantially received within said channel without overlap; and
securing said second end of said tensile element to a terminal, said terminal being off said hoistway door panel; and
moving the door from the door open position to the door closed position through an intermediate position closer to the door closed position than to the door open position and delivering a first force from the tensile element to the door as said door moves from the intermediate position toward the door closed position that is greater than a second force delivered by the tensile element to the door through at least part of door movement from the door open position to the intermediate position.

2. The method of claim 1 further comprising the step of removing an existing door closure from the doorway panel, the existing door closure having a second sheave repeatedly circumscribed by a second elongate channel of constant diameter having a second elongate wound on the second elongate channel so that a closing force imparted to the door panel decreases substantially linearly from the door open position to the door closing position.

3. A method for facilitating closure of an elevator hoistway door movable between a door open position and a door closed position, comprising the steps of:
applying a door closing force to the hoistway door as the hoistway door moves from the door open position toward the door closed position that substantially linearly decreases from the door open position to an intermediate position and then increases from the intermediate position to the door closing position.

4. The method of claim 3 wherein the intermediate position is substantially closer to the door closed position than to the door open position.

5. The method of claim 4 wherein the intermediate position is about one foot from the door closed position.

6. The method of claim 3 wherein the door closing force is greater at the door closed position than at the door open position.

7. A door closing device comprising
a sheave having a central axis and a sheave body rotatable about the axis, the sheave body having a first groove providing a multiplicity of revolutions about the axis at a first diameter for storing a substantial length of tensile element and a second groove of conical helix shape merging with the first groove and terminating adjacent a central portion of the sheave;
an elongate tensile element in the first and second grooves having a free end for attachment to an object; and
a spring for rotating the sheave body and retracting the elongate tensile element by wrapping the same around the first and second grooves;
the relationship between the spring and the sheave acting to deliver a force when the elongate tensile element is wrapped intermediate the ends of the second groove that is greater than when the elongate tensile element begins to wrap onto the second groove.

8. The door closing device of claim 7 further comprising a flange connected to the sheave body on a side of the sheave body adjacent the second groove.

9. The door closing device of claim 8 further comprising a central passage extending through the sheave body and a bearing in the passage.

10. The door closing device of claim 8 wherein the flange extends radially away from the axis a distance at least as far as the first diameter.

11. The door closing device of claim 7 comprising a second flange connected to the sheave body on a side of the sheave body adjacent the first diameter and extends substantially beyond the first diameter.

12. The door closing device of claim 11 wherein the first mentioned flange and the second flange are of circular shape having a common outside diameter.

13. The door closing device of claim 11 further comprising a flange connected to the sheave body on a side of the sheave body adjacent the first diameter and extends substantially beyond the first diameter.

14. The door closing device of claim 11 wherein the second groove comprises at least a major part of one complete revolution about the axis and less than multiple revolutions about the axis.

15. The door closing device of claim 11 wherein the second groove comprises less than one complete revolution about the axis.
